(19) United States
(12) Patent Application Publication
(10) Pub. No.: US 2015/0295947 A1
(43) Pub. Date: Oct. 15, 2015

(54) METHOD AND SYSTEM FOR VERIFYING THE SECURITY OF AN APPLICATION WITH A VIEW TO THE USE THEREOF ON A USER DEVICE

(71) Applicant: PRADEO SECURITY SYSTEMS, Montpellier (FR)

(72) Inventor: Clement Saad, Lattes (FR)

(21) Appl. No.: 14/438,646

(22) PCT Filed: Oct. 29, 2013
(86) PCT No.: PCT/EP2013/072607

§ 371 Date: Apr. 27, 2015

(30) Foreign Application Priority Data
Oct. 29, 2012 (FR) 1260287

(51) Int. Cl. H04L 29/06

(52) U.S. Cl. CPC H04L 63/1425; H04L 63/20

(57) ABSTRACT

A method is provided for verifying the security of a computing application, including the following steps:
emission of at least one data item, called a request, relating to the application by a computing device, called the client device, to a remote device, called the analysis engine, via a communication network,
analysis of the application by the analysis engine after loading of the application onto the analysis engine, and
transmission from the analysis engine to the client device of at least one data item relating to the result of the analysis.

The invention relates to a method for verifying the security of a computing application with a view to the use thereof on a user device. It also relates to a system implementing such a method.

The field of the invention is the field of the analysis of programs or applications for computing devices with a view to detecting programs that are dangerous or potentially dangerous to the security of the device on which they will be used or installed, or to the security of a new application which will be installed on a device, or also to the security of the applications which are already installed on a device when a new application is installed. The invention relates more particularly to the applications intended to be used on terminals of the Srnartphone® or tablet type. Of course, the invention is not limited to Smartphones® or tablets and can be used for any computing device running with an operating system.

### PRIOR ART

There are currently numerous methods for verifying the security of an application, such as the methods implemented by computer programs commonly called antivirus programs.

When a given application is installed or used on a user device, such a computer or a terminal of the Smartphone type, the antivirus program which is also installed on the same user device makes it possible to detect if the given application is a virus or an application that could jeopardize the security of the device on which it is used or installed, intentionally or unintentionally.

In order to identify a dangerous application, the antivirus program carries out an analysis of each application. In most cases, this analysis comprises an analysis of the signature of the application, and/or a heuristic analysis or also an analysis of the behaviour of the application when it is used on the user device.

However, the current verification methods implemented by the antivirus programs have several drawbacks.

The antivirus programs need to be installed on the device on which the application is used. Now, these programs are very resource intensive and Smartphone-type terminals are not suited to the use of such programs.

Furthermore, a complete analysis of an application comprises an analysis of its behaviour when running, which requires installation of the application on the user device. Now, if the application is dangerous and not protected, installing it on the user device can cause damage to the user device, to data located on the device or to the confidentiality of this data, which is contrary to the initial and general objective of protecting the user device.

A purpose of the invention is to overcome the abovementioned drawbacks.

Another purpose of the invention is to propose a method and a system for verifying the security of an application for the user device that is less resource intensive than the current verification methods and systems.

Another purpose of the invention is to propose a method and a system for verifying the security of an application presenting less risk and less danger than the current verification methods and systems to the device on which it is desired to use the application.

Yet another purpose of the invention is to propose a method and system for verifying the security of an application that are more complete and more flexible than the existing methods and systems.

### DISCLOSURE OF THE INVENTION

The invention makes it possible to achieve at least one of the abovementioned purposes by a method for verifying the security of a computing application, called the target application, comprising the following steps:
emission of at least one data item, called a request, relating to said target application by a computing device, called the client device, to a remote device, called the analysis engine, via a communication network,
analysis of said target application by said analysis engine after loading said target application onto said analysis engine, and
transmission from said analysis engine to said client device of at least one data item relating to the result of said analysis.

By “loading of the application”, is meant the loading of an executable file of the application, optionally accompanied by the source code of the application, in the form of one or more compressed or uncompressed files.

Thus, the analysis of the target application is not carried out on the computing device on which the application will be used or installed but remotely on an analysis engine. Thus, as regards the client device which may be the user device, the method according to the invention is less resource intensive than the methods and systems of the state of the art.

Furthermore, the method according to the invention does not require having administrator rights on the user device, unlike the methods of the state of the art, which makes it possible to use it on terminals on which the user does not have the administrator rights, such as most Smartphones® and tablets.

Moreover, the method according to the invention makes it possible to carry out a detailed and complete analysis of a target application on the analysis engine, i.e. on a device other than the client/user device, without having to install the target application on the client/user device, which makes it possible to carry out a verification of the security of a target application which is less risky and less dangerous for the client/user device, compared with the methods of the state of the art which require the analyzed application to be installed on the client/user device in order to carry out a complete analysis of the application.

Finally, the method for verifying security allows more complete and more flexible protection than the existing methods. In fact, for a given target application, the method according to the invention can be used to safeguard the security:
of the device on which it is desired to install the target application by seeking the points of the target application that are weak or dangerous to the device, for example by detecting dangerous excessive use of a processor of the device that may damage it;
of the applications present on the device on which it is desired to install the target application, for example by detecting unauthorized access to confidential data handled by another application executed by the device; and/or
of a third-party application that it is desired to install on the device on which the target application is already installed/executed, for example by detecting an opening of a communication port that is incompatible with the use of the third-party application.

In a first version of the method according to the invention, the request emitted by the client device to the analysis engine can comprise a data item relating:
to an address for loading the target application from another device, and/or
to a data item for identifying the target application oh another device;
   said method also comprising, prior to the analysis step, a step of loading said target application onto said analysis engine from said other computing device.

In this first version, the target application is therefore loaded onto the analysis engine from a computing device other than the client device.

In a first case where the target application is analyzed with a view to the use thereof on a user/client device, it is possible not to load the target application onto the user/client device, as long as the analysis is not completed. Thus, in this alternative, the method according to the invention makes it possible to avoid any loading of the target application onto the client/user device in the case where the analysis of the target application shows that the target application is not secure or presents a danger to the client/user device or to an application already present on the client/user device. Of course, even though it is possible not to load the target application onto the user/client device, this does not deny the prior loading of the target application onto the user/client device.

In this first case, the at least one data item relating to the result of the analysis of the target application sent to the client device can comprise the data constituting said target application, said application analyzed in this way being loaded onto said client device from the analysis engine only if the security of the application is satisfactory.

Still in this first case, the at least one data item relating to the result of the analysis can alternatively be a data item relating to the level of security of the application, such as “protected application”, “unprotected application” or a level of security associated with said target application following said analysis. When the security of the target application is satisfactory, the method according to the invention can also comprise a step of loading the target application onto the client device or a user device from another device. When the security of the application is not satisfactory, the application is never loaded onto the client/user device.

In a second case where the target application is analyzed in order to determine whether a third-party application can be used in a secure manner on the device on which the target application is executed, the target application is already installed/executed on the client/user device. In this second case, the analysis of the target application can be carried out with respect to at least one predetermined security rule defining a security policy associated with the third-party application or under the conditions of use of the third-party application on a computing device.

In this second case, the at least one data item relating to the result of the analysis of the target application can be a data item relating to the compatibility of the target application with the third-party application, such as for example “compatible applications”, “incompatible applications”.

Still in this second case, if the data item relating to the result of the analysis of the target application authorizes the use of the third-party application on a device also comprising the target application, then the method according to the invention can also comprise a step of loading and/or installing and/or executing the third-party application on the client/user device from the analysis engine or another device.

In a second version of the method according to the invention, the request emitted from the client device to the analysis engine can comprise the data constituting the target application, said target application being loaded onto said analysis engine during the step of emission of the request from said client device.

In this second version of the method according to the invention, the target application is necessarily present on the client device when the request is sent to the analysis engine. Thus, either the target application is an application already installed and executed on the client device or it is loaded onto the client device during a loading step carried out just before the step of sending the request to the client device.

If the method according to the invention comprises such a step of loading the target application, the loading of the target application onto the client device can be carried out from another device via an Internet-type communication network, for example in the case where the client device is a Smartphone, or from a local storage means to the client device, in the case where the device is an application server or a platform offering applications, which are paid-for or not paid-for, to user devices, such as for example App store®.

In a first case where the target application is analyzed with a view to the use thereof on the user/client device, the method according to the invention can comprise a step of installing said target application onto the client device with an execution restriction prior to the step of transmission of at least one data item relating to the result of the analysis. Such an installation step is particularly useful when the client device is the terminal for the execution and use of the application. Thus, while the application is being tested on the analysis engine, it is installed on the terminal where it is desired to be used, which allows significant time saving. If the data item relating to the result of the analysis received following the analysis authorizes the use of the application, then it is enough to simply lift the execution restriction and the application is ready to be used. If not, the application is uninstalled.

In this first case, the data item relating to the result of the analysis can comprise a data item relating to the security of the target application, of the “secure application”, “unsecure application” type, etc.

In a second case where the target application is analyzed in order to determine whether a third-party application can be used in a secure manner on the device on which the target application is executed, the target application is installed and executed on the client/user device. In this second case, the analysis of the target application can be carried out with respect to at least one predetermined security rule defining a security policy associated with the third-party application or under the conditions of use of the third-party application on a computing device.

In this second case, the data item relating to the analysis can comprise at least one data item relating to the security of the third-party application or to the compatibility of the third-party application with the target application or the device concerned, for example a data item of the “compatible”, “non-compatible” type etc.

In this second case, if the data item relating to the result of the analysis of the target application authorizes the use of the third-party application on a device also comprising the target application, then the method according to the invention can also comprise a step of loading and/or installing and/or executing the third-party application on the client/user device from the analysis engine or another device.

The data provided by the analysis of the target application can comprise an analysis report processed either in the analysis engine or in the client device or a user device in order to deduce therefrom:
a data item authorizing or denying use, or
a data item relating to a level of security of the target application, or
a data item relating to the compatibility of a third-party application with the target application and vice-versa, optionally with respect to a security policy attached to the device or to the third-party application and comprising at least one security rule.

The analysis step can comprise an analysis, called static analysis, of at least one part of an executable file and/or of the source code of said target application.

Advantageously, the analysis step can comprise, additionally or alternatively, an analysis, called dynamic analysis, comprising the following operations:
execution of the application on the analysis engine or on a device linked to the analysis engine, and
analysis of at least one data item relating to the running/behaviour of the application.

The purpose of such an analysis is to determine the behaviour in use of an application and to detect the dangers or risks presented by the application, during the use thereof, to the security of the device on which the application is used.

The dynamic analysis can be advantageously carried out in a computing environment identical or similar to an environment of the current or expected use of said application.

In this case, the method according to the invention can also comprise a step of transmission, from the client device to the analysis engine, of at least one data item relating to said environment of current or expected use. Such a transmission of data can be carried out during the step of sending the request, in addition to the request, or directly within the request.

The step of analysis, and more particularly of static analysis or dynamic analysis, comprises a verification or analysis of at least one data item relating to:
a network connection used/requested by the application,
an origin of the application,
declared function of the application,
a function carried out by the application,
an input handled by the application,
a signature of the application,
an output provided by the application, and/or
a resource used by the application.

The at least one data item relating to the result of the analysis can comprise an electronic certificate, called a security certificate, for said application, certifying a level of security associated with said application.

The security level(s) can be basic, for example “secure application” or “unsecure application”, or described in detail with a security gradation, for example “unsecure application”, “secure application with risk”, “secure application”, “well secure application”, “very well secure application”, etc.

The at least one data item relating to the result of the analysis can comprise, additionally or alternatively, a data item relating to the granting or denial of authorization for the installation or execution of the target application or of a third-party application.

If the data item relating to an authorization is a granted authorization data item, then the target application or the third-party application is installed and executed on the client device. It before the granted authorization data item is obtained, the application is installed with an execution restriction, then the reception of the granted authorization data item results in the lifting of the restriction on use so that the application can be executed.

The method according to the invention can also comprise a step of verifying conformity of the target application with at least one rule, called a security rule, defined beforehand, and optionally composing a security policy, for example attached to a third-party application or to a device.

Such a verification step can be carried out on the analysis engine or on the client device. In this case, the method according to the invention can comprise a step of loading the rule(s) concerned onto the device carrying out the verification.

Such a security rule can relate to the data accessed by the target application, to the data sent by the target application, to a connection used by the target application with an external device or a communication network, etc.

Thus if the target application complies with the security policy then the use thereof is authorized on the device in question or it is compatible with the use of a target application for which the security policy in question is defined.

In an advantageous version, the method according to the invention can be implemented each time a new application is installed on a device or each time an existing application on a device is updated.

According to another aspect of the invention, a system is proposed for verifying the security of a target application comprising means configured for implementing the steps of the method according to the invention.

Other advantages and features will become apparent on examination of the detailed description of examples which are no way limitative and the attached drawings in which:

FIG. 1 is a diagrammatic representation of a first example of a method according to the invention; and

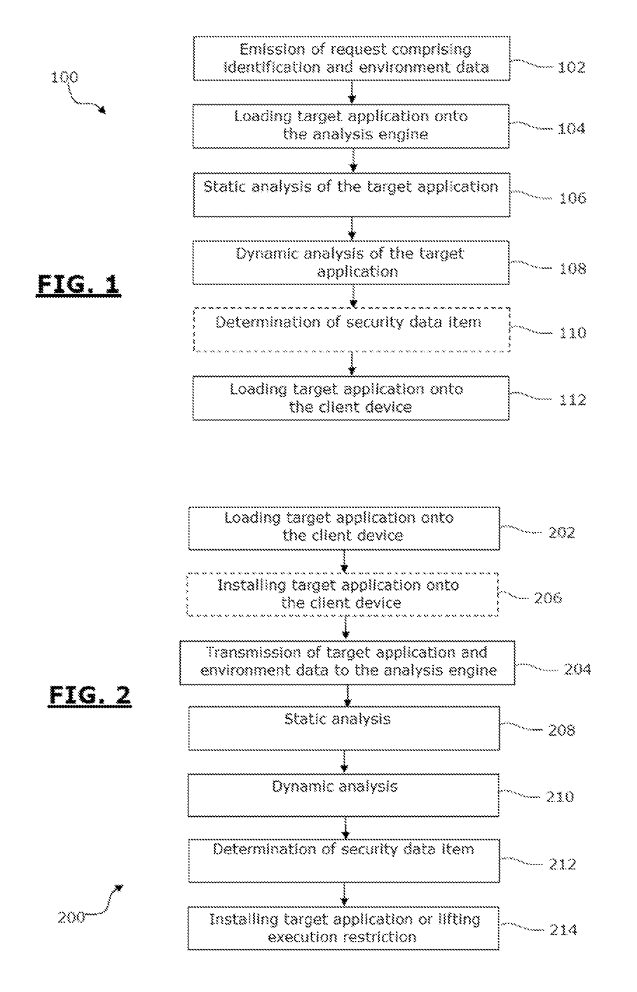

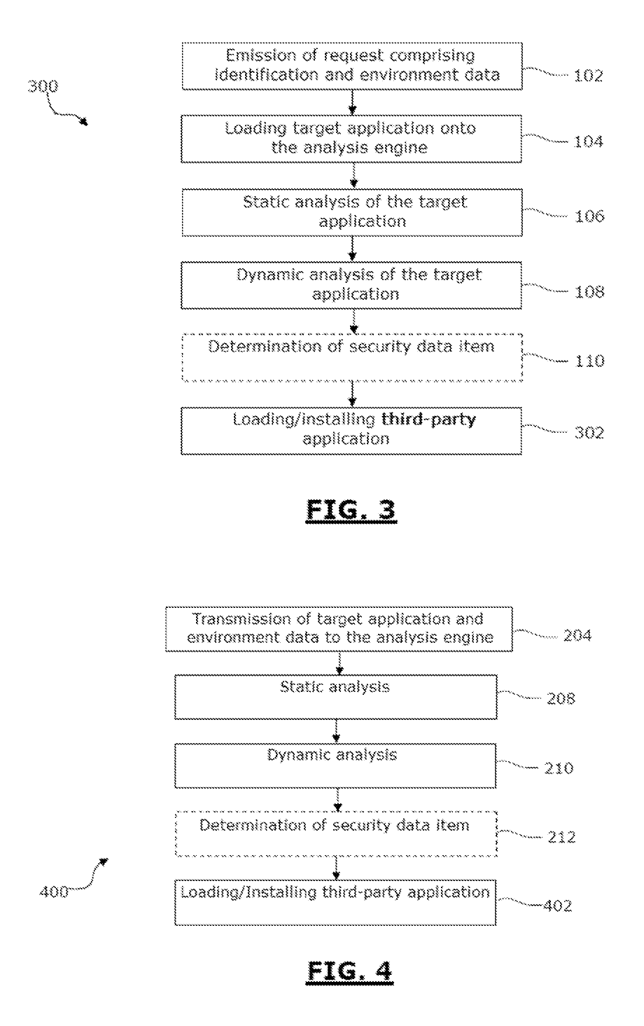

FIG. 2 is a diagrammatic representation of a second example according to the invention; and

FIG. 3 is a representation of a third example of a method according to the invention;

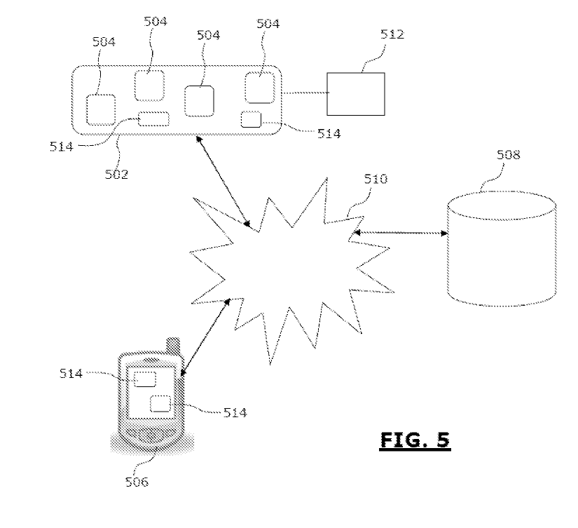

FIG. 4 is a representation of a fourth example of a method according to the invention; and

FIG. 5 is a diagrammatic representation of an example of a system implementing the method according to the invention.

It is well understood that the embodiments described hereinafter are in no way limitative. Variants of the invention can in particular be envisaged comprising only a selection of the features described below in isolation from the other described features, if this selection of features is sufficient to confer a technical advantage or to differentiate the invention from the state of the prior art. This selection comprises at least one preferred functional feature without structural details, or with only a part of the structural details if this part alone is sufficient to confer a technical advantage or to differentiate the invention from the state of the prior art.

In particular, all the described variants and embodiments can be combined if there is no objection to this combination from a technical point of view.

In the figures, the elements common to several figures retain the same reference numbers.

FIGS. 1 and 2 are diagrammatic representations of two embodiment examples of a method according to the invention for verifying the security of a target application with a view to the use thereof.

FIG. 1 is a diagrammatic representation of a first example of a method according to the invention.

The method 100 of FIG. 1 comprises a step 102 of emission of a request, from a client device to a remote device, called the analysis engine, via a communication network.

The request comprises data for identifying an application, called a target application, which must be analyzed in order to verify the security of the target application, with a view to the use thereof on the client device or another device linked to the client device.

The data for identifying the target application can comprise the full name of the target application, the version of the target application, and/or the address for loading the target application.

The request can also comprise data relating to the environment in which the target application is used, such as for example the type of device on which the target application will be used, the configuration of the device in terms of resources, etc.

The communication network can be the Internet or GPRS network or also a 3G- or 4G-type mobile telephony network.

In step 104, the target application is identified and the executable file of the application is loaded onto the analysis engine from a communication network which can be the same as that used during step 102 or another network.

The target application loaded onto the analysis engine undergoes static analysis, i.e. analysis of its executable file, in step 106.

Then in step 108, the target application undergoes a dynamic analysis. In order to do this, a virtual environment, simulating the device on which the application will be used, is created on the analysis engine as a function for example of data, received during step 102, relating to the environment in which the target application is/will be used.

Such an environment can be created by creating virtual machines on a physical machine. In order to do this, a virtualisation software can be used. Such software can be for example the XEN software running directly on the physical machine. Such software has the advantage of being able to run several operating systems on a single physical machine.

The static analysis and the dynamic analysis provide analysis data from which security data can be determined during an optional step 110, carried out either in the analysis engine or in the client device, for example with respect to at least one security rule attached or not attached to the device to which the use of the target application relates.

When the static and dynamic analyses are satisfactory, i.e. the security data item does not reveal any danger or risk, then a step 112 carries out the loading of the target application onto the client device and the target application can be used directly on the client device or another device linked/connected to the client device. Alternatively, the target application can be loaded onto the client device well before step 112, and optionally installed on the client device with an execution restriction. In this case, step 112 carries out an installation of the previously loaded target application or a lifting of an execution denial, the target application being installed beforehand.

When the static and dynamic analyses are not satisfactory, i.e. the security data item expresses a danger or a risk, then the target application is not loaded onto the client device or is manually deleted from the client device if it has already been loaded or installed with an execution restriction.

FIG. 2 is a diagrammatic representation of a second example of the method according to the invention.

The method 200 of FIG. 2 comprises a step 202 of loading the target application onto the client device, i.e. loading the executable file of the target application onto the target device. The loading can be carried out from a remote device via an Internet-type communication network or a 3G- or 4G-type mobile telephony network or from a local device or local storage means.

Then, during a step 204 the data representing the target application, i.e. the data representing the executable file of the application, loaded in step 202 are transmitted to the analysis engine via a communication network which can be the network used during step 202 or another network. During this step, data representing the environment in which the application is used can also be transmitted to the analysis engine.

The data relating to the environment in which the target application is used can comprise data representing the type of device on which the application will be used, the configuration of the device, etc.

The security of the target application is verified with a view to the use thereof on the client device or another device linked to the client device. Such a verification can be carried out with respect to at least one predefined security rule, attached or not attached to the device concerned.

The method 200 can comprise an optional step 206, carried out before, during or after step 204, and carrying out the installation of the target application onto the client device or another device linked to the client device with an execution restriction.

Once the target application is loaded onto the analysis engine, a step 208 carries out a static analysis of the executable file of the application.

Then in step 210, the target application undergoes a dynamic analysis. In order to do this, a virtual environment, simulating the device on which the application will be used, is created on the analysis engine as a function of the data received during step 204.

The static analysis and the dynamic analysis provide analysis data from which security data are determined during a step 212, carried out either in the analysis engine or in the client device, for example with respect to at least one security rule attached or not attached to the device with which the use of the target application is concerned.

If the security data item is determined in the analysis engine then it is transmitted to the client device during this step 212.

When the static and dynamic analyses are satisfactory, i.e. the security data item does not reveal any dander or risk, then a step 214 carries out an installation of the target application or a lifting of an execution restriction if the target application has been installed beforehand during a step 206 for example.

When the static and dynamic analyses are not satisfactory, i.e. the security data item reveals a danger or a risk, then the target application is deleted from the client device, preferably manually. If it has already been installed, during the optional step 206, the restriction of use is maintained until the target application is removed.

Although described for a single target application, the methods 100 and 200 can be used in order to verify the security of several target applications simultaneously. In this case, each of the steps of the methods 100 and 200 are carried out for each of the applications in turn or at the same time.

FIGS. 3 and 4 are diagrammatic representations of two embodiments of a method according to the invention for verifying the security of a target application used on a device with a view to the use on this device of a third-party application, in other words for verifying the compatibility of one or more target applications located on a device with a third-party application with a view to the use of the third-party application on this device.

FIG. 3 is a diagrammatic representation of a third example of the method according to the invention; and

The method 300 of FIG. 3 comprises a step 102 of emission of a request from a client device to a remote device, called the analysis engine, via a communication network.

The request comprises data for identifying one or more applications, called target application(s), used on the client device or on a device connected/linked to the client device, and which must be analyzed in order to verify the security of a third-party application provided in order to be used on the device on which the target application (the target applications) is(are) used. Such a verification can be carried out, for each target application, with respect to at least one predefined security rule, attached or not attached to the third-party application.

The data for identifying each target application can comprise the full name of the target application, the version of the target application, and/or the address for loading the target application.

The request can also comprise data relating to the environment in which each target application is used, such as for example the type of device on which the target application is used, the configuration of the device in terms of resources, etc.

The communication network can be the Internet or GPRS network or also a 3G- or 4G-type mobile telephony network.

In step 104, each target application is identified and an executable file of each target application is loaded onto the analysis engine from a communication network which can be the same as that used during step 102 or another network. Each target application is loaded onto the analysis engine from a device other than the client device,

Each target application loaded onto the analysis engine undergoes a static analysis, i.e. an analysis of its executable file, in step 106.

Then in step 108, each target application undergoes a dynamic analysis. In order to do this, a virtual environment, simulating the device on which the application will be/is used, is created on the analysis engine as a function for example of data relating to the environment in which the target application received during step 102 is used.

Such an environment can be created by creating virtual machines on a physical machine. In order to do this, a virtualisation software can be used. Such software can be for example the XEN software running directly on the physical machine. Such software has the advantage of being able to run several operating systems on a single physical machine.

The static analysis and the dynamic analysis provide analysis data from which security data can be determined during an optional step 110, carried out either in the analysis engine or in the client device, for example with respect to at least one security rule attached or not attached to the third-party application.

When the static and dynamic analyses are satisfactory, i.e. the security data item does not reveal any danger or risk, then a step 302 carries out the loading of the third-party application onto the device on which the tested target application(s) are located and on which the third-party application will also be used. This step 302 can also carry out the installation of the third-party application on this device, and optionally, the execution of the third-party application.

Alternatively, the third-party application can be loaded onto the client device well before step 302, and optionally installed on the client device with an execution restriction. In this case, step 302 carries out an installation of the previously loaded third-party application or a lifting of an execution denial of the previously installed third-party application.

When the static and dynamic analyses are not satisfactory, i.e. the security data item reveals a danger or a risk, then the target application is not loaded onto the client device or is deleted from the client device if it has already been loaded or installed with an execution restriction, preferably manually.

FIG. 4 is a diagrammatic representation of a fourth example of a method according to the invention.

The method 400 of FIG. 4 comprises a step 204 transmitting the data representing the target application(s), used on the client device or on a user device linked/connected to the client device to the analysis engine via a communication network. Of course each target application used on the client device or the user device has been loaded onto this device beforehand. The data loaded onto the analysis engine comprise for each target application an executable the of the target application.

During this step 204, data representing the environment in which each target application is used can also be transmitted to the analysis engine. The data relating to the environment in which the target application is used can comprise data representing the type of device on which the application will be/is used, the configuration of the device, etc.

Each target application will thus be analyzed in order to verify the security of a third-party application expected to be used on the device on which the target application is used. Such a verification can be carried out, for each target application, with respect to at least one predefined security rule, attached or not attached to the third-party application.

Once the executable file of each target application is loaded onto the analysis engine, each target application undergoes a static analysis of its executable file, in step 208.

Then in step 210, each target application undergoes a dynamic analysis. In order to do this, a virtual environment, simulating the device on which the application will be used, is created on the analysis engine as a function of the data received during step 204.

The static analysis and the dynamic analysis provide analysis data from which security data are determined during an optional step 212, carried out either in the analysis engine or in the client device. If the security data item is determined in the analysis engine then it is transmitted to the client device during this step 212.

When the static and dynamic analyses are satisfactory, i.e. the security data item does not reveal any danger or risk, then a step 402 carries out the loading of the third-party application onto the device on which the target application or applications tested are located and on which the third-party application will also be used. This step 402 can also carry out the installation of the third-party application on this device, and optionally, the execution of the third-party application.

Alternatively, the third-party application can be loaded onto the client device well before step 402, and optionally installed on the client device with an execution restriction. in this case, step 402 carries out an installation of the previously loaded third-party application or a lifting of an execution denial of the previously installed third-party application.

When the static and dynamic analyses are not satisfactory, i.e. the security data item reveals a danger or a risk, then the third-party application is not loaded onto the client device or is manually deleted from the client device if it has already been loaded or installed with an execution restriction.

Although described for a single third-party application, the methods 300 and 400 can be used for a verification of security with a view to the use of several third-party applications simultaneously. In this case, the analysis data provided by the static and dynamic analyses of each of the target applications are processed with respect to the security rules attached to each of the third-party applications and/or with respect to the security rules common to all the third-party applications.

Although described for a third-party application, the methods 300 and 400 can also be used for a verification of security of the target applications present on a device, for example the client device, without the objective of using a third-party application. In this case, the security rule or rules are those defined for the device executing the target applications. In this case steps 302 and 402 are not carried out.

FIG. 5 is a diagrammatic representation of an example of a system implementing the method according to the invention; and

The system 500 comprises an applications server 502 comprising one or more applications 504 intended to be used on user devices.

The system also comprises one or more user devices such as for example a Smartphone® 506 and an analysis engine 508 which can be a server or a computerized system capable of executing one or more computer programs.

Each of the applications 504 can be loaded onto the server 502 either via a communication network 510 such as the Internet network or a 3G- or 4G-type mobile telephony network or from a device or a local storage means 512, in an automated or manual manner.

The client device 506 also comprises applications 514 installed and used on the client device.

In the system 500, each application 504 is analyzed on the analysis engine 508 with a view to the use thereof on the client device 506. In this case each of the applications 504 is a target application within the framework of the methods 100 and 200 of FIGS. 1 and 2.

Moreover, each of the applications 514 present on the client device 506 is also analyzed in order to verify their security with a view to the use of applications 504 on the client device 506. In this case, each application 514 is a target application and each application 504 is a third-party application within the framework of the methods 300 and 400 of FIGS. 3 and 4.

The system 500 can be arranged in order to implement different versions of the method according to the invention, each version corresponding to any combination of the possibilities described below if there is no objection to this combination from a technical point of view,

Each application 504 and 514 can be loaded onto the analysis engine 508 either via the Smartphone® 506 or directly from the applications server 502 without passing through the Smartphone® 506, via the network 510.

When the application is loaded onto the analysis engine 508 via the Smartphone® 506, it is loaded beforehand onto the Srnartphone 506 from the applications server 502. The application can also be installed on the Smartphone® 506 with an execution denial until security data or analysis data are received.

When the application is loaded directly from the applications server 502, the loading can be initiated either directly by the applications server 502, or by the analysis engine 508 on the basis of identification data received by the Smartphone® 506 beforehand.

In the case where the loading of an application 504 onto the analysis engine is initiated by the server 502, such loading can be initiated in an automated manner each time a new application is loaded onto the server 502, for example from the local storage means 514, or each time a user emits a request for loading an application 504. In this case, the application can be denied from being loaded until the security or analysis data are received.

Once the application has been analyzed by the analysis engine, the security data or the analysis data can be transmitted by the analysis engine 508, either to the applications server 502 or to the Srnartphone® via the network 510. In most cases, the data relating to the result of the analysis, namely the analysis data or the security data, are transmitted by the analysis engine 508 to the device which initiates the analysis of the application.

When the analysis of an application is requested by the applications server 502, the reception by the applications server 502 of the security or analysis data will lead to the lifting of a loading denial, thus authorizing the loading of an application 504 onto the Smartphone® 506 or to the deletion of an application 504 from the applications server 502 or also to the sending of data refusing authorization for the loading of an application 304 to the Smartphone® because the applications 514 present on the Smartphone® are not protected.

When the analysis of an application is requested by the Smartphone® 506, the reception by the Smartphone® 506 of security or analysis data will lead to the lifting of an installation or execution denial, thus authorizing the installation/execution of an application 504 on the Smartphone® 506 or to the deletion of an application 504 or also to abandoning the loading of an application 504 from the server 502.

In order to carry out each of the steps of the methods 100-400 described above, or more generally the steps of the method according to the invention, the applications server and/or the Smartphone® comprise (each comprises a local interface.

Of course, the invention is not limited to the examples that have just been described.

1. A method for verifying the security of a computing application, called the target application, comprising the following steps:
emission of at least one data item, called a request, relating to said target application by a computing device, called the client device, to a remote device, called the analysis engine, via a communication network,
analysis of said target application by said analysis engine after loading said target application onto said analysis engine, and
transmission from said analysis engine to said client device of at least one data item relating to the result of said analysis;
the analysis step comprises an analysis, called dynamic analysis, of said target application comprising the following operations:
execution of the application on the analysis engine or on a device linked to the analysis engine, and
analysis of at least one data item relating to the running/behaviour of said target application.

2. The method according to claim 1, characterized in that the request comprises a data item relating:
to an address for loading the target application from another device, and/or
to a data item for identifying the target application on another device;
said method also comprising, prior to the analysis step, a step of loading said target application onto said analysis engine from said other computing device.

3. The method according to claim 2, characterized in that the at least one data item relating to the result of the analysis of the target application comprises the data constituting said target application, said target application thus analyzed being loaded onto said client device from the analysis engine.

4. The method according to claim 1, characterized in that the request emitted from the client device to the analysis engine comprises the data constituting the target application, said target application being loaded onto said analysis engine during the emission step of said request from said client device.

5. The method according to claim 4, characterized in that it also comprises a step of installing said target application onto the client device with an execution restriction prior to step of transmission of at least one data item relating to the result of the analysis.

6. The method according to claim 1, characterized in that it also comprises a step of loading and/or installing and/or executing a third-party application which is different from the analyzed target application, on the client device or a user device which is different from the client device.

7. The method according to claim 1, characterized in that the analysis step comprises an analysis, called static analysis, of at least one part of an executable file of the target application.

8. The method according to claim 1, characterized in that the dynamic analysis is carried out in a computing environment identical or similar to an environment of current or expected use of said application, said method also comprising a step of transmission from the client device to the analysis engine, of at least one data item relating to said environment of current or expected use.

9. The method according to claim 1, characterized in that it comprises a step for verifying conformity of the target application with at least one rule, called a security rule, defined beforehand.

10. The method according to claim 1, characterized in that the analysis step comprises verification or analysis of at least one data item relating to:
a network connection used/requested by the target application;
an origin of the target application;
a declared function of the target application;
a function carried out by the target application;
an input handled by the target application;
a signature of the target application;
an output provided by the target application; and/or
a resource used by the target application.

11. The method according to claim 1, characterized in that the at least one security data item comprises an electronic certificate, called a security certificate, for said target application certifying a level of security associated with said target application.

12. The method according to claim 1, characterized in that the at least one security data item comprises a data item relating to the granting or denial of authorization for the installation or execution of the target application or of a third-party application.

13. The method according to claim 1, characterized in that it is implemented each time a new application is installed on a device or each time an existing application on said device is updated.

14. A system for securing the use of a computing application, comprising means arranged in order to carry out the steps of the method according to claim 1.
